(19) United States
(12) Patent Application Publication
(10) Pub. No.: US 2004/0245166 A1
(43) Pub. Date: Dec. 9, 2004

(54) Water filter media

(76) Inventor: James Rice, Arlington, WA (US)

Correspondence Address: JENSEN + PUNTIGAM, P.S., SUITE 1020, 2033 6TH AVE, SEATTLE, WA, 98121, US

(21) Appl. No.: 10/458,556

(22) Filed: Jun. 9, 2003

(51) Int. Cl. B01D 35/00

(52) U.S. Cl. 210/435; 210/500.1

(57) ABSTRACT

A filter media for use in flowing water, which provides a large surface area for habitat of microorganisms that consume pollutant material.

### TECHNICAL FIELD

This invention relates to water filtration, and more particularly to a synthetic ribbon, which is extremely thin and wide, thereby providing a substantial surface area to support the microorganisms, which then consume the pollutants as the water flows by or through a container full of the filtering media.

### BACKGROUND OF THE INVENTION

As potable water has become more and more precious because of the shortage of supply, it has become more critical that means be applied to convert otherwise contaminated water into potable water.

Many filtration and water purification systems are known, but these systems normally require a replacement of the filter medium or recharging of the purification product.

Water treatment methods and devices known to the present include:

U.S. Pat. No. 4,376,675, granted to Perrotta Mar. 15, 1983, discloses a method of manufacturing a fibrous non-woven flow filter tube and the filter tube so prepared, wherein the filter tube is non-woven, self-supporting and composed of the filter fibers.

U.S. Pat. No. 5,268,093, granted to Hembree et al Dec. 7, 1993, discloses a potable water purification system, including a multi-unit nesting apparatus, wherein the contaminated water is forced through biocidally effective material into a second container.

U.S. Pat. No. 5,945,005, granted to Junius et al Aug. 31, 1999, discloses a filter system, including a tank with a conveyor for conveying filter media from a filter zone in the tank to a quiet zone where the trapped predetermined matter separates from the filter media and is withdrawn from the tank.

U.S. Pat. No. 5,989,424, granted to Serenko et al Nov. 23, 1999, discloses a replaceable filter cartridge for use in a water filtration device, wherein the water is placed in a first container and is gravity fed through the filter medium into a second container.

U.S. Pat. No. 6,383,375 B1, granted to Zucholl May 7, 2002, discloses a water container with a filter cartridge, wherein the water enters the filter from the bottom and is moved upward through the filter and then through a drop tube to a drain at the bottom of the tank.

U.S. Pat. No. 6,383,395 B1, granted to Clarke et al May 7, 2002, discloses a water treatment method and apparatus, wherein the filter media is specifically formulated to remove selected ingredients from the water, including arsenite.

U.S. Pat. No. 6,485,641 B1, granted to McLeod Nov. 26, 2002, discloses water filter cartridge, including a proportional flow feeder and including treatment by a solid compound for a slipstream of untreated water flowing through the cartridge.

U.S. Pat. No. 6,517,720 B1, granted to Aldred et al Feb. 11, 2003, discloses an escutcheon-mounted filter, including an above counter access for cartridge renewal.

U.S. Pat. No. 6,517,724 B1, granted to Malone Feb. 11, 2003, discloses an air-charged backwashing bioclarifier, wherein air is accumulated in a charge chamber, which is then triggered to do a backwash cycle.

### SUMMARY OF THE INVENTION

The present invention discloses improved water filter media, in that the surface area of the media is substantial, allowing the pollutant consuming microbes to attach themselves to the media and remain in the fluid stream.

In one embodiment of the present invention, the water filter media includes a strip of polyethylene ribbon, which is approximately 0.002 of an inch thick and 3 inches wide.

In another embodiment of the present invention, the filter media is a polyethylene ribbon no more than 0.002 of an inch thick, 3 inches wide and thinner along the edges, allowing the ribbon to wrinkle or curl, providing more water contact and microbe supporting surface.

A complete embodiment of the present invention includes a plurality of the individual polyethylene ribbons, which are then compressed into a container, and the water flows through the container and over the filter media and the attached microorganisms.

### BRIEF DESCRIPTION OF THE DRAWINGS

FIG. 1 discloses a strand of plastic ribbon.

FIG. 2 is an enlarged section of the plastic ribbon of FIG. 1.

FIG. 3 is a schematic showing the utilization of the filter ribbons in a filter tank having the water to be filtered forced therethrough.

### BEST MODE FOR CARRYING OUT THE INVENTION

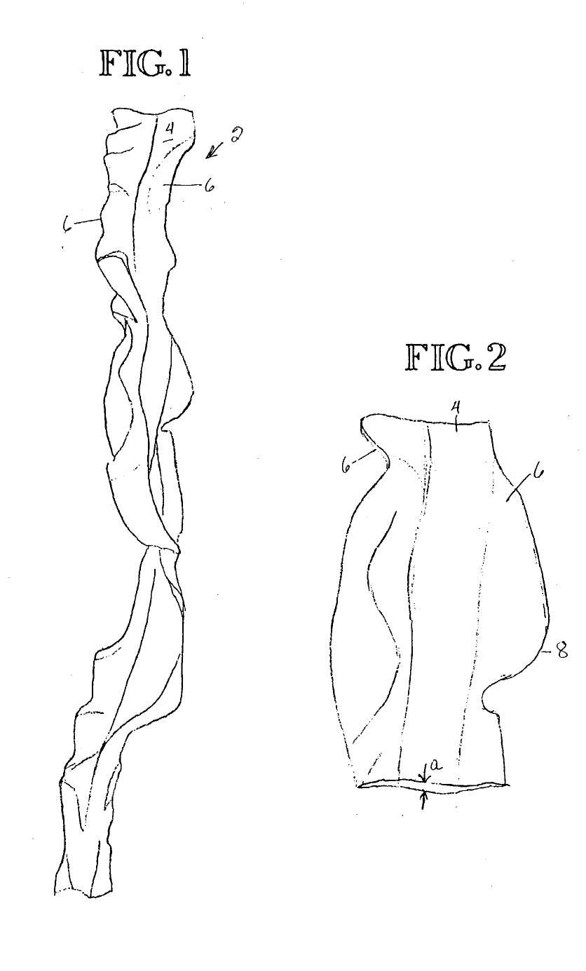

As seen in FIG. 1, the ribbon generally illustrated as 2 is elongated, has a generally uniformly thick center portion 4, which preferably is approximately 0.002 or less in thickness, is approximately 3 inches in width and is flanked on both sides by outwardly tapering edges 6, such that the entire structure assumes a curly configuration, offering a substantial amount of surface area to attract the microorganisms that consume the waste or pollutants as the water flows thereby.

As best seen in FIG. 2, which is an enlarged or shortened portion of the ribbon shown in FIG. 1, the center portion 4 is of substantially uniform thickness of 0.002 of an inch or less as seen at “a” and then the side portion 6 slowly tapers from the thickness of 4 to a very thin edge at 8. The tapering of the ribbon causes the ribbon to pucker or crinkle, therefore creating an uneven, suitable surface for the microorganisms, which attach themselves and consume the pollutants.

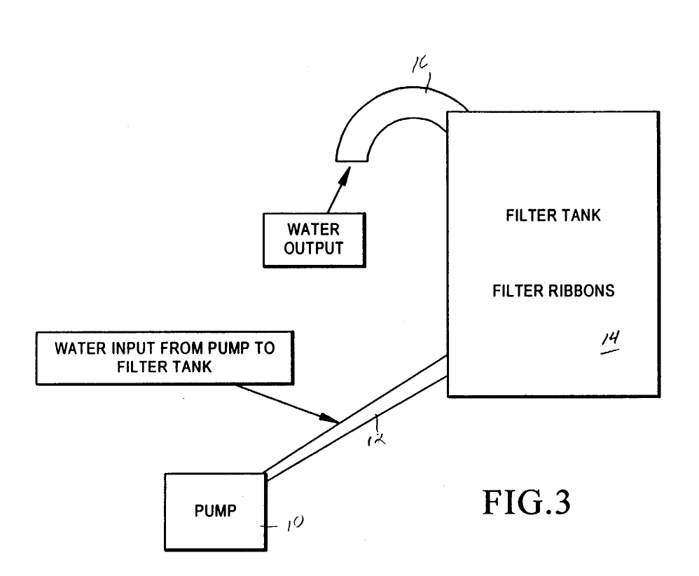

As seen in FIG. 3, there is a schematic showing a general outline for the preferable utilization of the filter media herein and above described when utilized in a pond or pool, wherein the pump 10 would be connected to a conduit 12 channeling the contaminated fluid into the bottom of a filter tank 14, which can be a closed container of suitable size and suitable material. The cleaned and filtered fluid then exits through the output conduit 16 for re-entering the pond or pool as clean and aerated water.

It can be seen that the present invention provides a simple, straightforward, inexpensive method of controlling the water quality of a pond or pool without the requirement of back flushing or replacement of filters, in that the polyethylene ribbons as herein and above described provide an excellent nurturing situation for the microbes that attach themselves and clean the water as it passes thereby.

1. A filter medium, comprised of a plurality of polyethylene ribbons captured in a suitable container, said container including at least two openings such that liquid under pressure will enter the container at the first opening and exit at the second opening after circulating through the filter medium.

2. A water filter ribbon, comprising a single strand of polyethylene ribbon no more than 0.002 of an inch thick and 3 inches wide.

3. A filter medium as in claim 1, wherein the polyethylene ribbons are 0.002 of an inch thick.

4. A filter as in claim 2, wherein the ribbon is thinner along the edges.

5. A filter medium for use in a flowing stream of water providing a relatively large surface area to support pollution ingesting microorganisms, comprising an elongated, wide, thin strip of plastic having tapered edges to cause it to wrinkle, such that when grouped with similar media in a relatively confined flow-through container, effectively cleans the contaminants from the water.
